(19) United States
(12) Patent Application Publication
(10) Pub. No.: US 2007/0112622 A1
(43) Pub. Date: May 17, 2007

(54) Web-based incentive system and method

(76) Inventor: Anthony F. Meggs, Melbourne, FL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/267,210

(22) Filed: Nov. 7, 2005

(51) Int. Cl. G06Q 30/00

(52) U.S. Cl. 705/14

(57) ABSTRACT

A method for providing an incentive to an Internet user to interact with a website. The present invention includes a network capable of capturing a portion of money related to Internet commerce, and allocating said money in a manner that provides incentive to an Internet user to interact with a website.

### FIELD OF THE INVENTION

The present invention relates generally to a network. More particularly, the present invention relates to a system and method for providing an incentive to network users.

### BACKGROUND OF THE INVENTION

Paid search marketing programs are in wide use across the Internet. In these known marketing programs, Internet vendors selling products, services, or information bid in an open auction environment for positions on a search result list generated by an Internet search engine. For example, Internet vendors agree to pay a certain amount to the search engine provider in exchange for a favorable position on the search result list. Payments are often directly related to the number of “click-thrus” generated by the search result list.

The higher an Internet vendor's position on a search result list, the higher likelihood of a “click-thru.” Thus, these known marketing programs provide incentive for the Internet vendor to select and highly bid on those search keywords or phrases that are most relevant to their website offerings.

In addition to a favorable position on the search result list, the likelihood of a “click thru” also depends on the Internet user's personal incentive to click on the Internet vendor's hyperlink. One of the more prevalent incentives is the user's desire to view the vendor's products, services, or information. Thus, the vendor's position on the search result list combined with the user's desire to view the vendor's products, services, or information combine to determine, in large part, whether the user will actually “click-thru” to the vendor's website.

Known search marketing programs do not provide incentive to “click-thru” beyond the user's desire to view the vendor's products, services, or information and strategic positioning of the hyperlink. Current systems provide incentive to Internet vendor's to bid on favorable positions on search result lists. For example, increased traffic on an Internet vendor's website results in increased sales revenue. Moreover, current systems also provide incentive to the search engine provider to create a more efficient system. For example, Google AdWords has been visited by millions of Internet users, and has generated billions of dollars in paid search revenue for Google.

There is a need to provide additional incentive to Internet users and, thus, even further increase the effectiveness and efficiency of paid searching marketing programs. An exemplary way to provide additional incentive to an Internet user is to direct a benefit to the Internet user in exchange for the Internet user's “click-thru.” Another exemplary way to provide additional incentive to an Internet user is to direct a benefit to a third-party beneficiary in exchange for the Internet user's “click-thru.” Additional incentive is provided by enabling the Internet user to designate the third-party beneficiary. Accordingly, it is desirable to provide a method and system capable of concurrently providing incentive to the Internet users and fulfilling the Internet vendors' interest in effectively marketing to Internet users.

The present invention fulfills these interests by providing a system and method for enabling an Internet user to direct a benefit to himself or to a third-party beneficiary by interacting with an Internet vendor's website. For example, the system and method provides a paid search engine marketing system, wherein the Internet vendor donates money to an account owned by the Internet user or to a charity designated by the Internet user—instead of only paying the search engine administrator—upon an a “click-thru” or some other Internet user action. The system and method of the present invention will provide incentive to Internet users to “click-thru” and thereby increase effectiveness and efficiency of the paid searching marketing program.

### SUMMARY OF THE INVENTION

The foregoing needs are met, to a great extent, by the present invention, wherein in one aspect a system is provided that in some embodiments enables an Internet user to donate to a beneficiary by interacting with an Internet vendor's website.

In accordance with one embodiment of the present invention is a system for enabling an Internet user to appropriate a benefit by interacting with a website that is promoted by an Internet vendor, comprising an Internet vendor account for each of a plurality of Internet vendors registered in the system, wherein the Internet vendor account includes a pledge amount; an Internet user account for each of a plurality of Internet users registered in the system; and a smart client configured to present data of the Internet vendor account, monitor a user activity of the Internet user, and provide the user activity to a web server, wherein the web server is configured to allocate the benefit based on the user activity.

In accordance with another embodiment of the present invention is a method for enabling an Internet user to appropriate a benefit by interacting with a website that is promoted by an Internet vendor, comprising: maintaining a database having stored thereon: an Internet vendor account for each of a plurality of Internet vendors registered in the system, wherein the Internet vendor account includes a pledge amount; an Internet user account for each of a plurality of Internet users registered in the system; monitoring a user activity of the Internet user; cross-referencing the user activity with data located in the Internet vendor account to identify a common term; presenting data that is located in the Internet vendor account when the common term is identified; monitoring an interaction between the Internet user and the website that is promoted by the Internet vendor; and allocating the benefit.

In accordance with yet another embodiment of the present invention is a method for providing an incentive to an Internet user to interact with a website, comprising: monitoring a user activity of an Internet user; searching a database for an Internet vendor based on the user activity; presenting a hyperlink to a website that is maintained by the Internet vendor; monitoring an interaction between the Internet user and the website; and allocating a benefit.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating the relationship between a large network and an embodiment of the network participants.

FIG. 2 is a block diagram illustrating the relationship between a large network and an embodiment of the system and method for enabling an Internet user to indirectly donate to a beneficiary by interacting with an Internet vendor's website.

FIG. 3 is a flowchart illustrating an exemplary process invoked by the system and method for enabling an Internet user to indirectly donate to a beneficiary by interacting with an Internet vendor's website.

FIG. 4 is a block diagram illustrating a server and exemplary programs stored therein and executed therefrom according to one embodiment of the present invention.

FIG. 5 is a chart of menus, display screens, and input screens used in one embodiment of the present invention.

FIG. 6 is a flowchart illustrating an exemplary process invoked by the system and method for enabling an Internet user to indirectly donate to a beneficiary by interacting with an Internet vendor's website

FIG. 7 is a chart of menus, display screens, and input screens used in one embodiment of the present invention.

FIG. 8 is a chart of menus, display screens, and input screens used in one embodiment of the present invention.

FIG. 9 is a chart of menus, display screens, and input screens used in one embodiment of the present invention.

FIG. 10 is a chart of menus, display screens, and input screens used in one embodiment of the present invention.

FIG. 11 illustrates an example of a search result list generated by one embodiment of the present invention.

### DETAILED DESCRIPTION

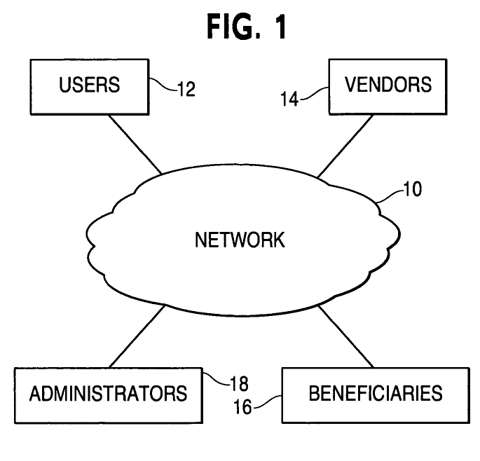

FIG. 1 represents a network 10 capable of enabling an Internet user 12 to capture and redirect a portion of an Internet vendor's search marketing and advertising dollars. The network 10 enables the Internet user 12 to redirect said captured dollars to a beneficiary 16. The beneficiary 16 can be an account owned by the Internet user 12 or an account owned by a third-party. As shown in FIG. 1, the network 10 includes Internet users 12, Internet vendors 14, beneficiaries 16, and administrators 18.

In an embodiment, beneficiaries 16 are accounts owned by the Internet user 12. For example, the beneficiary 16 can be the user's 12 IRA account, membership rewards account, the user's college saving account, the user's health saving account, etc. In another embodiment, beneficiaries 16 are accounts owned by third-party organizations, e.g., charitable organizations that generate some portion of their revenue in the form of donations. Internet users 12 are those engaged in Internet activity and interested in supporting beneficiaries 16. Internet vendors 14 are organizations interested in effectively marketing to Internet users 12 and willing to support the user's favorite beneficiaries 16 in exchange for said effective marketing. Administrators 18 manage the network 10.

The network 10 is capable of concurrently fulfilling at least four interests: 1) the Internet user's 12 interest in finding specific products or services 2) the Internet users' 12 interest in supporting at least a beneficiary 16; 3) the Internet vendors' 14 interest in effectively marketing to Internet users 12; and 4) the beneficiaries' 16 interest in collecting support. It should be appreciated that the beneficiaries' 16 interest and the Internet users' 12 interest are substantially similar when the Internet user 12 has an interest in the beneficiary 16. For example, the Internet user has an interest in the beneficiary 16 when the beneficiary 16 is an account owned by the Internet user 12.

First, the Internet user's 12 interest in finding specific products or services is fulfilled because, in an embodiment, the present invention enables the Internet user 12 to conduct a keyword search in a search engine (e.g., GOOGLE, MSN, YAHOO, etc) or on a website having its own search engine. The systems and methods of the present invention automatically detect and monitor the search activity. Based on the detected search activity, the present invention conducts a search of Internet vendors 14 that provide the sought products or services. The present invention presents the uniform resource locators (URLs) of the applicable Internet vendors 14.

It should be appreciated that the aforementioned example is illustrative and there exists multiple embodiments of the present invention capable of fulfilling the Internet user's interest in finding specific products or services. For example, an Internet vendor can access the present invention and designate the URLs of competitors that offer related products and services. If the Internet user 12 accesses a designated competitor URL, the present invention can present the Internet vendor's 14 URL to the Internet user 12. It should also be appreciated that the present invention can scan the context of the web page being viewed by the Internet user 12 for designated keywords and search terms. When an Internet user 12 lands on a web page containing designated keywords and search terms, the present invention can present the Internet vendor's 14 URL to the Internet user 12. It should also be appreciated that the Internet user 12 can conduct keyword search exclusively within the present invention. The aforementioned examples are discussed in more detail below.

Second, the Internet user's 12 interest in supporting beneficiaries 16 is fulfilled because the Internet vendor 14 donates to beneficiaries 16 based on the Internet user's 12 interaction with the Internet vendor's 14 website. Internet vendors 14 pledge donations to beneficiaries 16 contingent on Internet users' 12 interaction with Internet vendors' 14 respective websites. For example, an Internet vendor 14 can pledge a donation in exchange for Internet users' 12 providing their profile information to the Internet vendor 14 via the vendor's 14 website. Thus, an Internet user 12 can indirectly generate revenue for a beneficiary 16 by providing profile information to an Internet vendor 14.

Third, the Internet vendors' 14 interest in effectively marketing to the Internet users 12 is accomplished because network 10 provides significant incentive to the Internet user 12 to interact with the Internet vendors' 14 websites. The incentive exists because the amount of Internet user 12 activity with the Internet vendor's 14 website is directly proportional to the amount of support the Internet vendor 14 pledges to the beneficiary 16. This incentive will encourage many Internet users 12 to provide personal information to Internet vendor's 14, which can be used for effective marketing.

Fourth, the beneficiaries' 16 interests are satisfied because they receive revenue from Internet users 12 by-way-of the Internet vendors 14. It should be appreciated that beneficiaries 16 can be the Internet user's frequent flyer miles account, loyalty points account, 401k account, etc.

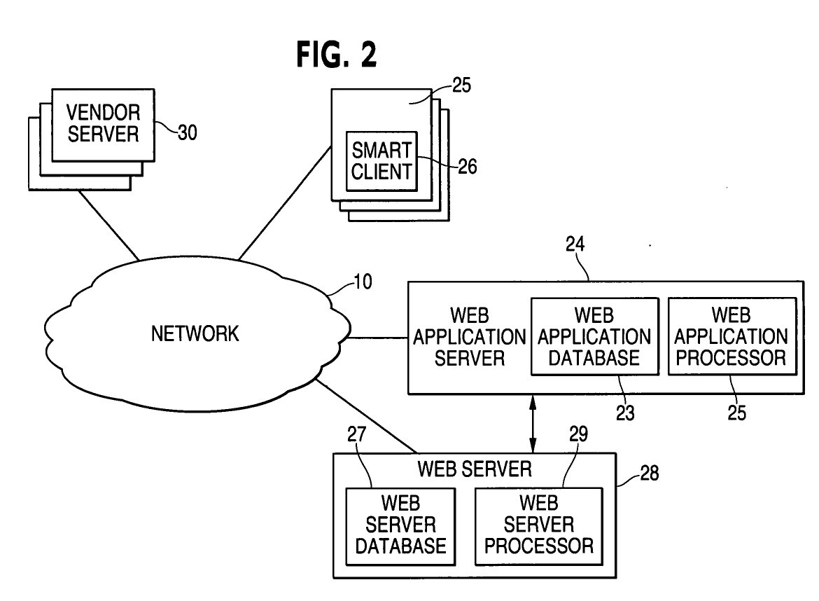

Referring now to FIG. 2, an example of the preferred architecture used in the network 10. In an embodiment, the network 10 is a client/server network such as the Internet. Thus, the terms network 10 and Internet are use interchangeably hereinafter. A client is as a requester of services and a server is a provider of services. For example, a client is a computer program running on a computer that accesses resources shared by a server, and the server is another computer running a corresponding server program.

As shown in FIG. 2, the network 10 includes a smart client 26 configured to request services from network 10 servers such as a web application server 24, a web server 28, and a vendor server 30. The smart client 26, for example, can run on a computer that accesses the network 10 resources provided by another computer running a corresponding server program. Although the system and method of the present invention is useful for the Internet, it should be understood that the client 26 and the servers 24, 28, and 30 may be connected together through one of a number of different typed of networks. Such networks may include local area networks (LANs), other wide area networks (WANs), and regional networks accessed over telephone lines, such as commercial information services. The client 26 and server 24, 28, and 30 processes may even include different programs executing simultaneously on a single computer.

The computers 25 on which the smart client 26 runs can be conventional personal computers (PCs), workstations, or computer systems of any other size. Each computer 25 typically includes one or more processors, memories, input/output devices, and a network interface. The servers 24, 28, and 30 can be similarly configured. However, the servers 24, 28, and 30 may each include many computers connected by a separate private network. In fact, the network 10 may include hundreds of thousands of individual networks of computers.

The smart client program 26 can execute within web browser programs, such as the NAVIGATOR, EXPLORER, or MOSAIC browser programs. The browser programs allow the Internet user 12 to enter addresses of specific web pages to be retrieved. These addresses are referred to as Uniform Resource Locators (“URLs”). In addition, once a page has been retrieved, the browser programs can provide access to other pages or records when the Internet user 12 “clicks” on hyperlinks to other web pages. Such hyperlinks are located within the web pages and provide an automated way for the user to enter the URL of another page and to retrieve that page. The pages can be data records including as content plain textual information, or more complex digitally encoded multimedia content, such as software programs, graphics, audio signals, videos, and so forth.

In an embodiment of the present invention, as shown in FIG. 2, the smart client 26 communicates, through the network 10, with various network information providers, including web application server 24, web server 28, and vendor servers 30 using the functionality provided by a HyperText Transfer Protocol (HTTP), although other communications protocols, such as FTP, SNMP, TELNET, and a number of other protocols known in the art, may be used. Preferably, the web application server 24, the web server 28, and the vendor servers 30 are located on the World Wide Web.

The web application server 24 includes a computer storage medium 23 and processing system 25. The storage medium 23 contains Internet user account information, Internet vendor account information, beneficiary account information, and administrator account information. It should be appreciated that the system and method of the present invention may be implemented in software that is stored as executable instructions on a computer storage medium, such as memories or mass storage devices, on the web application server 24. Conventional Internet browser programs, running on the client computers 25, may be used to by the Internet user 12, the Internet vendor 14, the beneficiary 16, and the administrator 18 to access their respective accounts stored on the web application server 24. Preferably, access to the web application server 24 is accomplished through a firewall, which protects the account information stored thereon from external tampering.

In an embodiment, the web server 28 is directly connected to the web application server 24 and the network 10. The web server 28 includes a computer storage medium 27 and a processing system 29. The storage medium 27 includes search listing records for generating search results in response to the Internet user 12 queries. It should also be appreciated that the present invention utilizes a natural language interpretation method to generate search results in response to Internet user's 12 activity. A search engine program operating on the web server 28 enables Internet users 12, upon submitting queries to the web server 28 through the smart client 26, to type keyword queries to identify pages of interest among the many webpages promoted by Internet vendors 14. It should be appreciated at the search engine program also enables Internet users 12 to type keyword queries to identify pages of interest among the many pages available on the World Wide Web that are not promoted by Internet vendors 14. Further, it should be appreciated that the search engine program enables Internet users 12 to identify only those pages of interest that are promoted by Internet vendors 14 that donate to beneficiaries 16 that are designated by the Internet user.

It should be appreciated that other embodiments exist for conducting searches. For example, a search engine that is not included in the present invention, e.g., GOOGLE, YAHOO, etc, can generate the search result. Based on the generated search result, a matching program operating on the web server 28 can search the storage medium 23 to locate relevant Internet vendor's 14 URLs. The relevant URLs can then be presented to the Internet user 12.

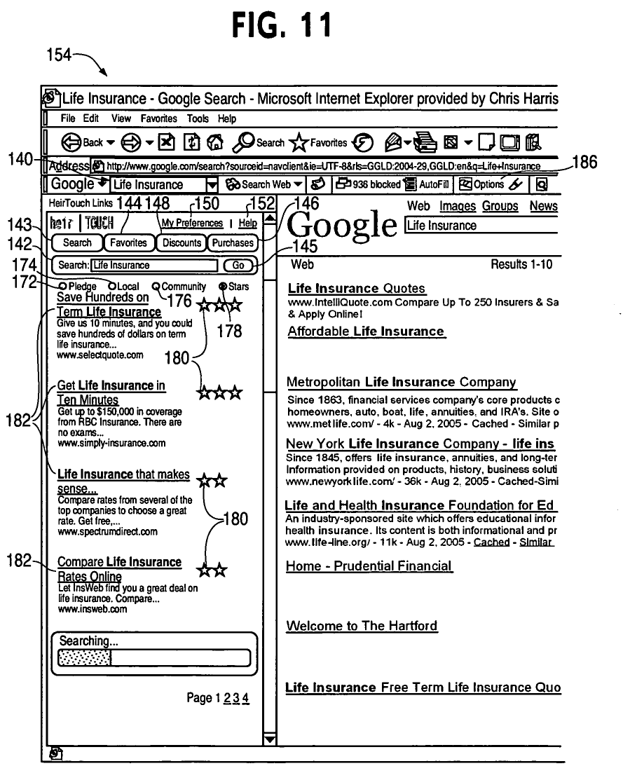

In an embodiment of the present invention, a search engine program is located on web server 28 and the search engine is configured to generate a search result list that includes, among other things, relevant entries obtained from and formatted by the beneficiary 16 designations as stored in the web application server 24. The web server 28 generates a list of hypertext links to documents that contain information relevant to search terms entered by the Internet user 12 and transmits this list to the Internet user 12 via smart client 26 interface. An example of such transmission via the smart client 26 interface is shown in FIG. 11, which will be discussed below in further detail.

The web application server 24 and the web server 28 address the different information needs of the Internet users 12, Internet vendors 14, and beneficiaries 16. However, it should be appreciated that the web application server 24 and the web server 28 can be combined into one server capable of serving the Internet users 12, Internet vendors 14, and beneficiaries 16.

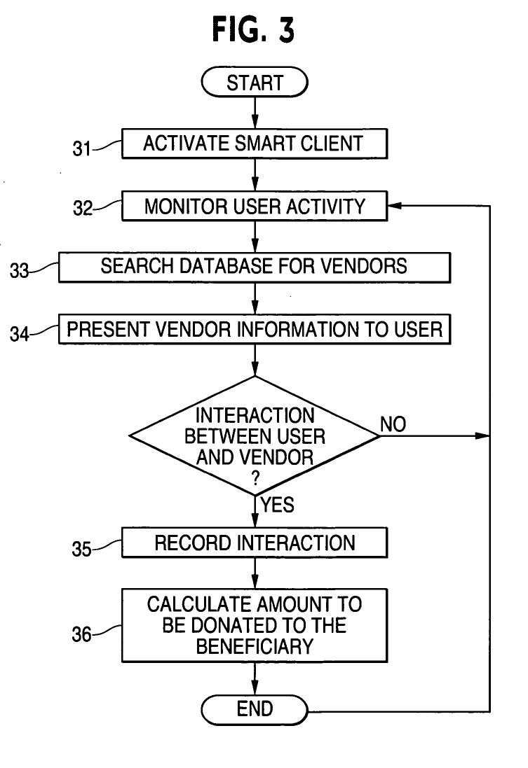

FIG. 3 is an example process executed by the system. First, as shown in step 31, the smart client 26 is activated. Upon activation, the smart client 26, in step 32, monitors the Internet activity of the Internet user 12. The smart client 26 transmits Internet user activity data to the web server 28. As shown in step 33, the system invokes a process on the web server processor 29. The invoked process searches the web server database 27 for target webpages. Target webpages are, for example, those webpages that have content relative to the Internet user's 12 activity and, in addition to relevancy, target webpages are promoted by Internet vendors 14.

Once target webpages are identified, the system presents the corresponding hyperlinks to the Internet user 12, as indicated by step 34. If the Internet user 12 does not click on the presented hyperlink, the system returns to step 32. If the Internet user 12 clicks on the presented hyperlink; this is known as a “click thru,” the system proceeds to step 35. In step 35, the system records the click-thru in the web application database 23. Next the system access the vendor's pledge amount and, based on the pledge amount, calculates the amount to be donated to the beneficiary 16, as shown in step 36.

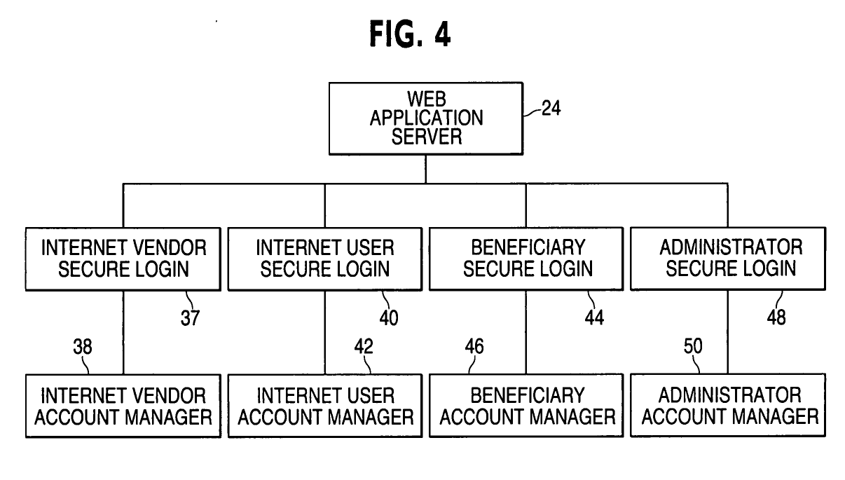

Shown in FIG. 4 are exemplary programs stored and executed on the web application server 24. The programs include a Internet vendor secure login 37, a Internet vendor account manager 38, an Internet user secure login 40, an Internet user account manager 42, a beneficiary secure login 44, a beneficiary account manager 46, an administrator secure login 48, and an administrator account manager 50.

For example, in operation the Internet vendor 14 can access the web application server 24 via the client computer 26, and the web application 24 presents the Internet vendor secure login 37. Upon access to the Internet vendor secure login 37, the Internet vendor 14 inputs a valid username and password.

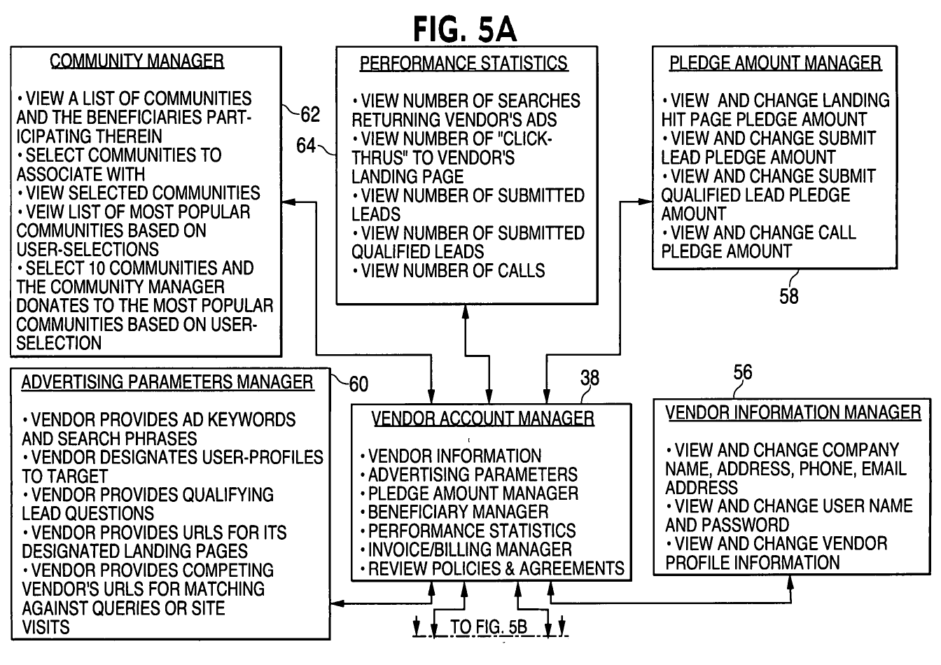

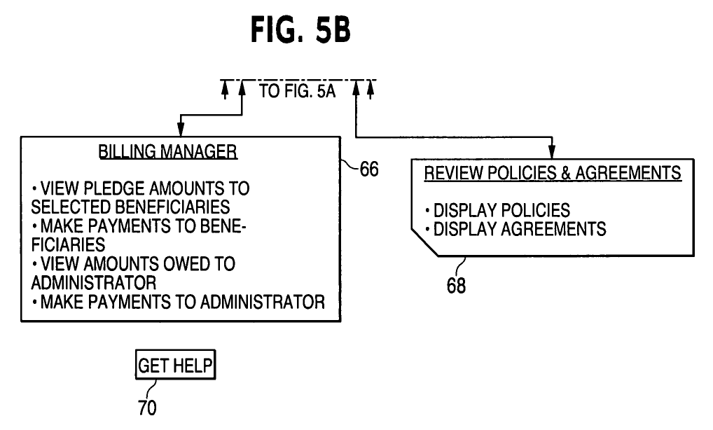

Referring now to FIG. 5, an exemplary embodiment of the vendor account manager 38 is shown. Upon a successful login, the web application server 24 provides the vendor account manager 38. The vendor account manager 38 has a number of options and further services for the Internet vendor 14. These items, which will be discussed in more detail below, cause routines to be invoked to either implement the Internet vendor's 14 request or request further information prior to implementing the Internet vendor's 14 request. In one embodiment of the present invention, the Internet vendor 14 may access several options through manager 38, such as the vendor information manager 56, the pledge amount manager 58, the advertising parameters manager 60, the community manager 62, the performance statistics manager 64, the invoice/billing manager 66, and policies and agreements viewer 68. A get help link 70 may also be available at the vendor account interface 34.

The vendor information manager 56 that enables an Internet vendor 14 to, among other things, view and change its contact information. For example, the Internet vendor 14 can view and update its address, phone number, email address, and billing information. The information manager 56 also allows the Internet vendor 14 to view and change its username and password. Further, the vendor 14 can view and change its profile information. For example, profile information includes whether the vendor 14 is a religious owned business, non-for-profit business, for-profit business, or a secular commercial business.

The pledge amount manager 58 allows the Internet vendor 14 to view and change its pledge amounts. Pledge amounts are donations given by vendors 14 to beneficiaries 16 in exchange for Internet users 12 interacting with the vendors' 14 websites. The Internet vendor 14 can designate pledge amounts based on the Internet user's 12 interaction with its website. For example, the Internet vendor 14 can pledge a specific amount for a landing hit page. A landing hit page occurs when an Internet user 12 clicks on the Internet vendor's 14 hyperlink and is thereby routed to the Internet vendor's specified landing webpage. Thus, when an Internet user clicks on the vendor's 14 hyperlink, the vendor 14 donates a designated pledge amount to the beneficiary 16.

In one embodiment, upon registering in the network 10, the Internet user 12 agrees to provide his/her profile information to Internet vendors 14 upon accessing landing webpages. Internet user 12 profile information, for example, includes the user's 12 location, age, sex, and income. Thus, each time an Internet user 12 accesses a landing webpage, the corresponding vendor 14 receives that particular user's 12 profile information, and in return, the vendor 14 donates to a beneficiary 16 as designated by the Internet user 12. Profile information is considered by many vendors 14 to be valuable information.

An advantage of the present invention is Internet vendors 14 are less susceptible to click-fraud. Click-fraud is a problem in the prior art because internet users can repeatedly click hyperlinks and thereby fraudulently deprive vendors of money. An embodiment of the present invention prevents click-fraud because each Internet user 12 agrees to register, and thereby provide his/her personal information, before using the network 10. Thus, an Internet user 12 cannot repeatedly interact with a Internet vendor's 14 website, and thereby fraudulent deprive the vendor 14 of money, without revealing his/her identity to the administrator 18. Because the administrator 18 can monitor all Internet user's 12 activity, the administrator 18 can either stop the user 12 continuing click fraud and/or reimburse the vendor 14 of fraudulently induced donations. Further, the administrator 18 can implement an algorithm to disable a user's 12 account if the user's 12 ratios of click-thrus to leads to qualified leads indicate click-fraud. Leads and qualified leads are discussed in further detail below.

The Internet vendor 14 can pledge a different amount in exchange for the Internet user 12 submitting a lead to the Internet vendor 14 by-way-of the Internet vendor's 14 website. A submit lead occurs when the Internet user 12 agrees to provide the Internet vendor 14 with more detailed information, such as a profile. Detailed profile information, for example, includes but not limited to the Internet user's 12 name, address, telephone number, and email address. In an alternative embodiment, the Internet vendor 14 can pledge another beneficiary 16 donation amount in exchange for the Internet user 12 submitting a qualified lead to the Internet vendor 14. A qualified lead occurs when the Internet user 12 agrees to answer qualifying questions as determined by the Internet vendor 14. Further, the Internet vendor 14 can pledge another amount in exchange for the Internet user 12 submitting a telephone call. This occurs when the Internet user 12, as a result of interacting with the Internet vendor's website, calls the Internet vendor 14.

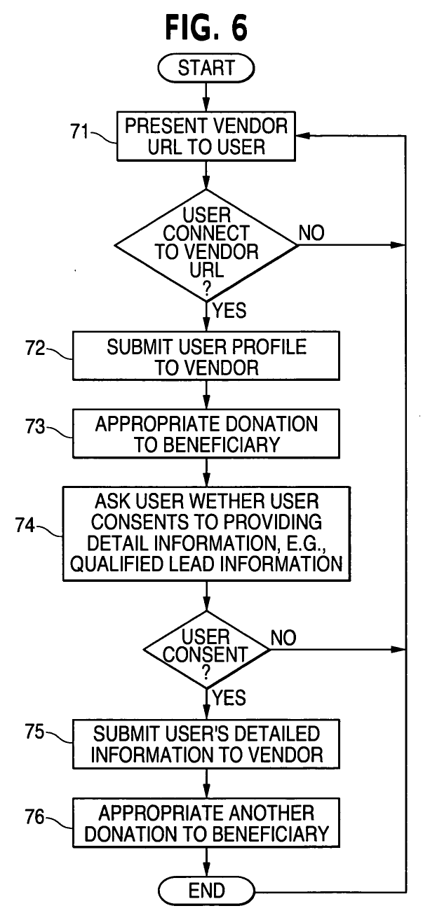

The aforementioned increasing pledge amount system can be understood by reference to FIG. 6. When the smart client 26 presents vendor 14 ad information to the user 12, as shown in step 71, the smart client 26 monitors the Internet user 12 activity. If the Internet user 12 does not interact with the vendor 14 ad information, the smart client 26 continues to present other vendor 14 ad information to the Internet user 12 and continues to monitor the interaction of the Internet user 12 with the vendor 14 ad information.

If the Internet user 12 does interact with the vendor 14 ad information, a function is invoked which receives data identifying the Internet user 12 and retrieves the user's 12 profile information from web application server 28. The executing process then submits the user's 12 profile information to the vendor 14 in step 72. The executing process invokes a function that retrieves the vendor's 14 pledge amount information from the web server 28. The executing process then access the vendor's account manager 42 and records the donation. Next, the executing process appropriates the donation to the beneficiary 16, as shown in step 73. It should be appreciated that donation can be appropriated in a number of ways. For example, the administrator can submit the donation to the beneficiary 16 and later bill the vendor 14. Also for example, the vendor 14 can donate directly to the beneficiation. It should also be appreciated that the aforementioned payments can be electronic transfers.

As shown in step 74, the smart client 26 next asks the user 12 whether the user 12 agrees to provide additional information to the vendor 14 in exchange for the vendor 14 donating another amount to the beneficiary 16. If the user 12 does not agree, then the executing process returns to step 71. If the user 12 agrees to provide additional information, then the process invokes a function that accesses the vendor's 14 account manager 38 to determine what addition user 12 information the vendor 14 wants and then prompts the user 12 to provide such information. It should be appreciated that the user 12 can submit the additional information via the smart client 26 interface or the executing process can automatically obtain the additional information from the web server 28. Next, in step 75, the user's 12 addition information is submitted to the Internet vendor 14.

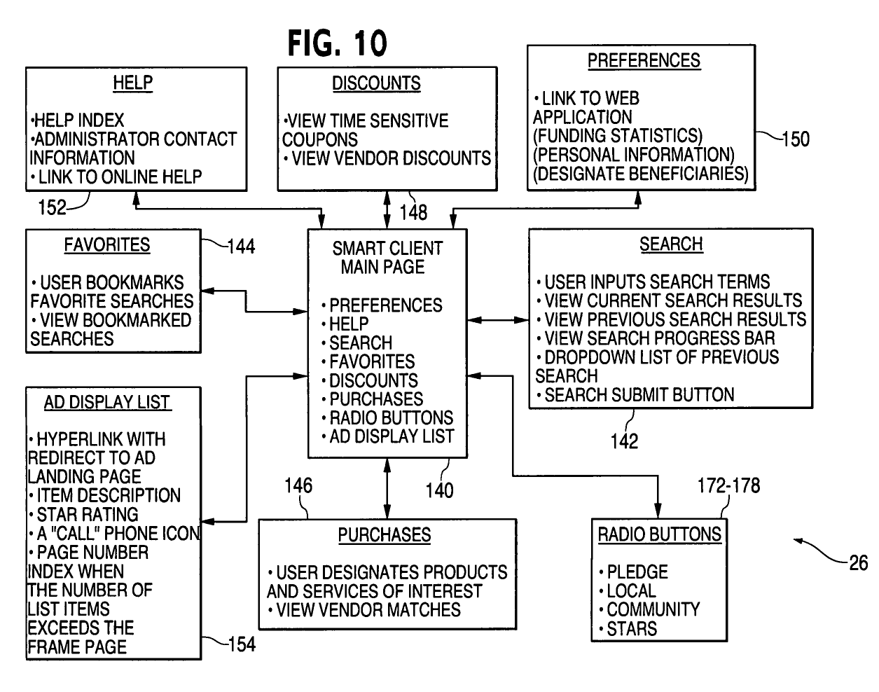

Next, the executing process invokes a function that retrieves the vendor's 14 pledge amount information. The executing process then accesses the vendor's account manager 42 and records the donation. Next, the executing process appropriates the donation to the beneficiary 16, as shown in step 76 and then returns to step 71. It should be appreciated that the executing process of FIG. 10 can be repeated a number of times. There is not limit to the amount of information the user 12 can provide to the vendor 14 and there is not a limit on the number of times the vendor 14 can donate to the beneficiary 16 in exchange for said information.

Referring again to FIG. 5, the advertising parameters manager 60 allows the vendor 14 to view and change parameters and affect the user's 12 attraction to the vendor's 14 website. For example, the vendor 14 can view and change ad keywords and search phrases. The vendor 14 selects ad keywords and search phrases that are relevant to the content of the vendor's 14 website. Ideally, the vendor 14 may select ad keywords and search phrases that are targeted keywords and phrases likely to be entered by users 12 while searching the Internet.

Internet vendors 14, via the advertising parameters manager 60, can designate target Internet user 12 profiles. As discussed in detail below, profile information for each registered Internet user 12 is stored in the database 22. The Internet vendor 14 can, for example, target users 12 based on their geographic location, age, sex, religious affiliation, etc. The vendor 14 selects user profiles consistent with the content of the vendor's 14 website and, thus, the targeted users 12 are likely to interact with the vendor's 14 website.

The advertising parameters manager 60 also enables Internet vendors 14 to view and change qualifying lead questions. Qualifying lead questions are questions designed to provide marketing information relative to the vendor's 14 defined market. For example, qualifying lead questions are designed to give the vendor data usefully for developing more efficient and effective marketing strategies. For example, a health insurance provider may asking the following qualified lead questions to the Internet user 12: 1) do you currently have insurance; 2) do you have any preexisting conditions; and 3) are you interested in a group or individual policy?

The advertising parameters manager 60 also enables Internet vendors 14 to view and change Uniform Resource Locators (URLs) that link users 12 to its designated landing pages. Also, vendors 14 can input a list of its competitors URLs. Thus, when a user 12 lands on a competitor's website, the smart client 26 will present the vendor's 14 URL to the user 12. The user 12 has incentive to click on the vendor's 14 hyperlink because, in exchange for the user's click, the vendor 14 will donate to the user's 12 designated beneficiary 16.

In an embodiment the community manager 62 enables the vendor 14 to select communities with which the vendor 14 wishes to associate. Communities, for example, consist of Internet vendors 14, Internet users 12, and beneficiaries 16 that belong to and/or support common religious, educational, ethnic, political communities, etc. Thus, for example, an Internet user's 12 search may be limited to those vendors 14 that associate with the Internet user's 12 designated communities. This community structure provides a granular way for Internet users 12, Internet vendors 14, and beneficiaries 16 to utilize the network 10 because it enables them to locate and support one another.

For example, the Internet vendor 14 is a small life insurance provider and, because of its limited size and available resources, it pledges a small amount relative to other life insurance providers. Further, the small life insurance provider, via the advertising parameters manager 60, designates “life insurance” as a search phrase and, via the community manager 62, designates “a local church” as a community with which it would like to associate. Because of its small pledge amount, the small life insurance provider may not appear on a search result list generated by the network 10 for an Internet user 12 searching the network 10 for “life insurance.”

The present invention addresses this concern by providing an option by which the small life insurance provider would appear on the Internet user's 12 search result list. For example, the small life insurance provider would appear on the search result list of an Internet user 12 that designates “the local church” as a community with which he or she would like to associate with and, further, the Internet user 12 utilizes a community search methodology. The local insurance provider appears because both it and the Internet user 12 associate with “the local church.” It should also be appreciated that the small life insurance provider would appear on the search result list of an Internet user 12 that designates “the local church” as a beneficiary 16 to which he or she would like to support.

The community search methodology provides a granular way for the Internet user 12 to find an Internet vendor 14 that is associated with one of his or her communities, e.g., “the local church.” The community search methodology is discussed in further detail below.

In an embodiment, the community manager 62 displays a list of all communities and the Internet users 12, Internet vendors 14, and beneficiaries 16 associated with the respective communities. Upon the Internet vendor's 14 request, the community manager 62 displays specific information about a particular community. For example, the vendor 14 can select a community, and the community manager 62 can display the community's mission statement, financial need, etc. The community manager 62 also contains a list of the most popular communities. The most popular communities, for example, are those communities comprising the largest number of Internet users 12, Internet vendors 14, and beneficiaries 16.

The vendor 14 can select communities by at least one of two ways. First, for example, the vendor 14 can manually select any number of registered communities. Second, for example, the vendor 14 can select ten registered communities and the community manager 62 will automatically associate with the most popular communities.

It should also be appreciated that within a particular community, a single entity can be an Internet user 12, an Internet vendor 14, and a beneficiary 16. For example, a community can comprise supporters of Campus Crusade, a Christian organization. Campus Crusade is an entity that consists of approximately one hundred ministries and ten thousand missionaries. Campus Crusade is supported, in part, by its donor base of approximately one million donors. The one million donors include, among others, Internet user's 12 and Internet vendor's 14, e.g., small businesses.

In one example, Campus Crusade is both an Internet user 12 and a beneficiary 16 when its agent accesses the network 10 to locate a product or service, e.g., a lawyer. In this example, it is in Campus Crusade's interest to locate a lawyer that is a member of the Campus Crusade community. Thus, Campus Crusade's agent accesses the network 10, as an Internet user 12, and searches for a lawyer. If the agent employees the community methodology, lawyers that associate with the Campus Crusade community will appear on the search result list. Thus, in this example, Campus Crusade is an Internet user 12 and a beneficiary 16. This is an example of the network 10 enabling a member to identify and utilize its constituency for its own benefit. It should also be appreciated that the lawyers in the Campus Crusade community can appear in the search result list in descending order based on their respective pledge amounts.

In another example, Campus Crusade is an Internet vendor 14. For example, Campus Crusade has an interested in spreading its Christian philosophy. To advance this interest, Campus Crusade can register in the network as an Internet vendor 14. Thus, providing incentive for Internet users 12 that are interested in generating support for their designated beneficiaries 16 to interact with Campus Crusades website. This is an example of the network 10 fulfilling Campus Crusade's interested in spreading Christianity and concurrently providing incentive to Internet users 12 to access the Campus Crusade website by supporting the internet user's 12 designated beneficiaries 16.

The performance statistics manager 64 can be accessed by the vendor 14 to obtain information relative to the vendor's 14 website traffic resulting from the network 10. For example, the performance statistics manager 64 provides the number of user 12 searches returning the vendor's 14 advertisements and/or hyperlinks. Also, the performance statistics manager 64 provides the number of “click thrus” to the vendor's 14 landing page, the number of submitted leads, the number of submitted qualified leads, and the number of user 12 calls made as a result of the vendor's 14 advertisements. It should be appreciated that the performance statistics manager 64 can be configured to provide other types of data compilations helpful to the vendor 14 in assessing its marketing success.

The billing manager 66 may be invoked from the vendor account manager 38. The billing manager 66 presents several choices to the vendor 14 for managing billing. For example, the vendor 14 can view a statement that details the amount the vendor 14 owes, in the form of donations, to each beneficiary 16. Also, the vendor 14 can make electronic payment directly to the beneficiaries 16 or the administrator 18. In one embodiment the vendor 14 donates directly to the beneficiary 16. In another embodiment, the vendor 14 transfers the donation to the administrator 18, and the administrator transfers the donation to the beneficiary 16. The billing manager 66 also provides a statement of service fees owned to the administrator 18 and the option off making electronic payments to the administrator 18.

The vendor 14 account manager 38 also includes a policy and agreement presenter 68. Upon initiation by the vendor 14, the policy and agreement present 68 displays current network 10 policies and agreements applicable to the vendor's 14 use of the network 10. These policies and agreements are defined by the administrator 18 and are agreed to by the vendor 14 during registration.

Referring again to FIG. 4, an exemplary embodiment of the web application server 24 comprising the Internet user secure login 40 and the Internet user main page 42. For example in operation, the Internet user 12 accesses the web application server 24 via a web browser operating in the client computer 25, and the web application server 24 presents the Internet user secure login 40. Upon access to the Internet user secure login 40, the Internet user 12 inputs a valid username and password.

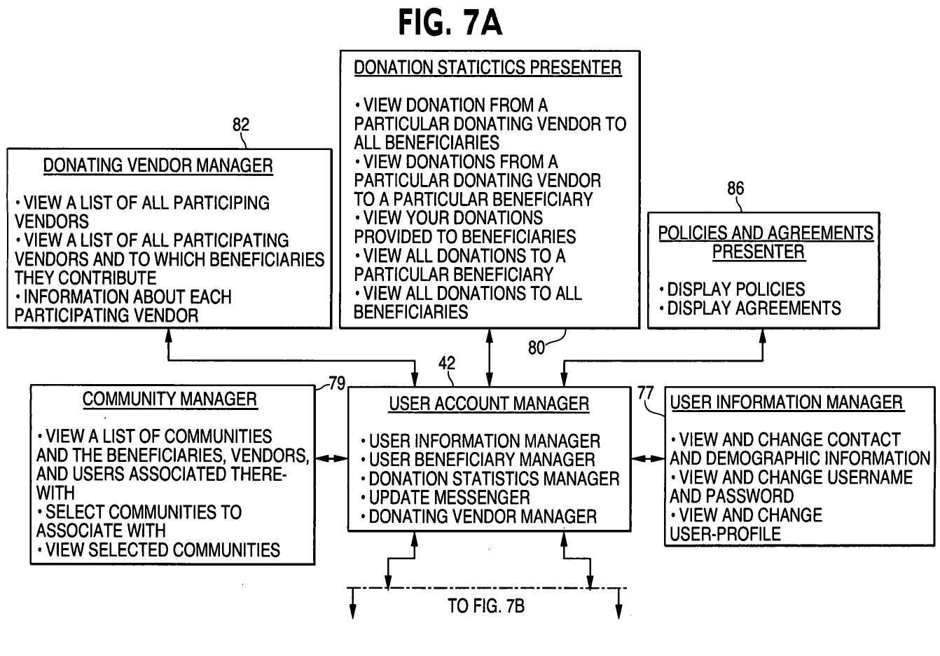

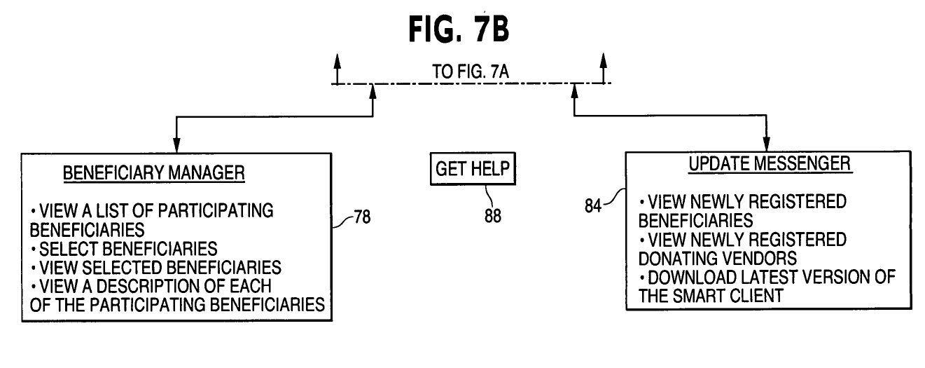

Referring now to FIG. 7, an exemplary embodiment of the Internet user account manager 42 is shown. Upon a successful login, the web application 24 provides the Internet user account manager 42. The Internet user account manager 42 has a number of options and further services for the Internet user 12. These items, which will be discussed in more detail below, cause routines to be invoked to either implement the Internet user's 12 request or request further information prior to implementing the Internet user's 12 request. In one embodiment of the present invention, the Internet user 12 may access several options through the Internet user account manager 42, such as the user information manager 77, the beneficiary manager 78, the community manager 79, the donation statistics presenter 80, the Internet vendor manager 82, the update messenger 84, and policies and agreements viewer 86. A get help link 70 may also be available at the user account interface 42.

The user information manager 77 enables an Internet user 12 to, among other things, view and change his/her contact information. For example, the Internet user 12 can view and update his/her address, phone number, email address, and billing information. The information manager 86 also allows the Internet user 12 to view and change his/her username and password. Further, the user 12 can view and change his/her profile information. For example, profile information includes the user's 12 age, sex, religious affiliation, location, etc.

The beneficiary manager 78 enables the user 12 to select beneficiaries 16 that best suit his/her preferences. The selected beneficiaries 16 will receive donations from an Internet vendor 14 upon the user's 12 interaction with the vendor's 14 website. In one embodiment, the beneficiary 16 receives a donation only when both the user 12 and the vendor 14 have designated that beneficiary 16. In another embodiment, the beneficiary 16 receives a donation if one of the user 12 and the vendor has designated that beneficiary 16. In the preferred embodiment, the beneficiary 16 receives a donation if the user 12 designates that beneficiary 16, and the Internet vendor 14 does not have an option of selecting beneficiaries 16. Instead, the Internet vendor 14 pledges to support the user's 12 designated beneficiaries 16.

The beneficiary manager 78 displays a list of all registered beneficiaries 16. Upon the user's 12 request, the beneficiary manager 78 displays specific information about a particular beneficiary 16. For example, the user 12 can select a beneficiary 16, and the beneficiary manager 78 can display the beneficiary's 16 information such as but not limited to a mission statement, financial need, location, URL, etc. The beneficiary manager 78 also contains a list of the most popular beneficiaries 16. The most popular beneficiaries 16, for example, are those beneficiaries 16 selected by the largest number of Internet users 12.

The user 12 can manually select any number of register beneficiaries 16. It should be appreciated that the user 12 can select all beneficiaries 16. It should also be appreciated that instead of affirmatively selecting beneficiaries 16, the user 12 can negatively select beneficiaries 16. For example, the user 12 can select beneficiaries 16 for which he/she does not want to generate donations. Thus, the user 12 can generate donations for all unselected registered beneficiaries 16.

In an embodiment, the community manager 79 enables the Internet user 12 to select communities with which he or she wishes to associate. Communities, for example, consist of Internet vendors 14, Internet users 12, and beneficiaries 16 that belong to and/or support common religious, educational, ethnic, political communities, etc.

In an embodiment, the community manager 79 displays a list of all communities and the Internet users 12, Internet vendors 14, and beneficiaries 16 associated therewith. Upon the Internet user's 12 request, the community manager 79 displays specific information about a particular community. For example, the Internet user 12 can select a community, and the community manager 79 can display the community's mission statement, financial need, etc. The community manager 79 also contains a list of the most popular communities. The most popular communities, for example, are those communities comprising the largest number of Internet users 12, Internet vendors 14, and beneficiaries 16.

The Internet user 12 can select communities by at least one of two ways. First, for example, the Internet user 12 can manually select any number of registered communities. Second, for example, the Internet user 12 can select ten registered communities and the community manager 79 will automatically associate with the most popular communities.

The performance statistics manager 80 can be accessed by the Internet user 12 to, among other things, obtain information relative to donations for which the user 12 is responsible. For example, the performance statistics manager 80 provides the number of “click thrus” the user 12 has made to register vendors' 14 landing pages and the donations generated therefrom. Also, the performance statistics manager 80 provides the number leads and qualified leads the user 12 submitted to registered vendors' webpages. The performance statistics manager 80 can display the total donations from a particular Internet vendor 14 and the applicable beneficiaries 16. The performance statistics manager 80 can also display the total donations from all participating Internet vendors 14 to a particular beneficiary 16. It should be appreciated that the performance statistics manager 80 can be configured to provide other types of data to help users 12 select Internet vendors 14.

The user account manager 42 also includes a Internet vendor manager 82. The Internet vendor manager 82 provides a list of all registered vendors 14 and the corresponding beneficiaries 16 to which they donate. The Internet vendor manager 82 also provides information to the Internet user 12 about each registered Internet vendor 14. Information provided by the Internet vendor manager 82 includes profile information, for example, whether the vendor 14 is a religious owned business, non-for-profit business, for-profit business, or a secular commercial business.

Further, the user account manager 42 includes an update messenger 84. The update messenger 84 provides the user 12 updates when new beneficiaries 16 register with the network 10. The messenger 84 includes the newly added beneficiaries' 16 respective profile information. The update messenger 84 also provides the user 12 updates when new Internet vendors 14 register with the network 10, and the messenger 84 provides profile information about each newly register Internet vendor 14. Further, the update messenger provides a hyperlink to the latest version of the smart client 26.

The user 12 account manager 42 also includes a policy and agreement presenter 86. Upon initiation by the user 12, the policy and agreement present 86 displays current network 10 policies and agreements applicable to the user's 12 use of the network 10. These policies and agreements are defined by the administrator 18 and are agreed to by the user 12 during registration.

Referring again to FIG. 4, an exemplary embodiment of the web application server 24 comprising the beneficiary secure login 44 and the beneficiary main page 46. For example, in operation the beneficiary 16 accesses the web application server 24 via a web browser operating in the client computer 25, and the web application server 24 presents the beneficiary secure login 44. Upon access to the beneficiary secure login 44, the beneficiary 16 inputs a valid username and password.

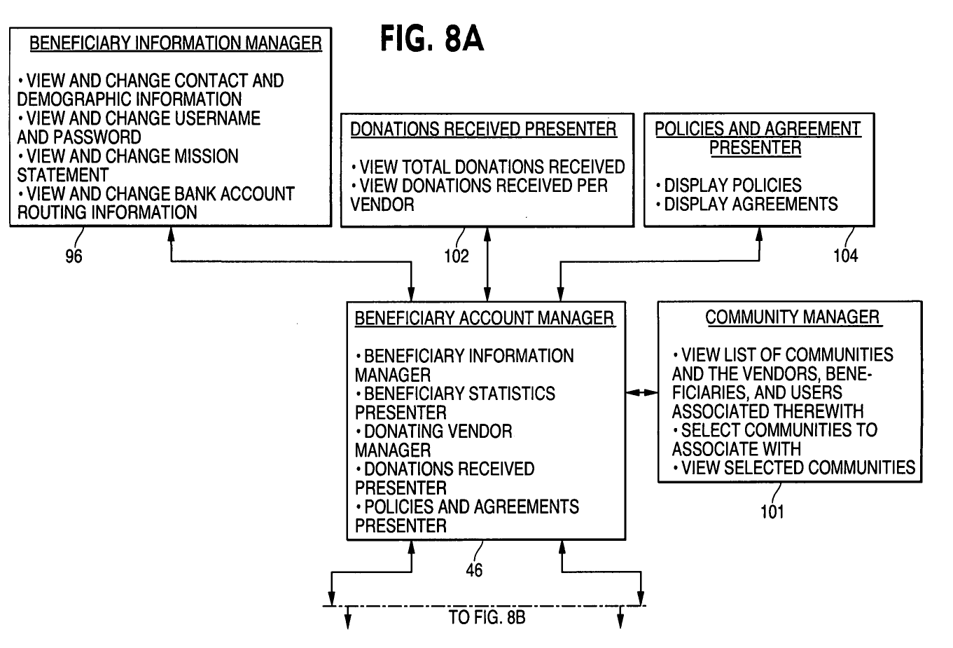

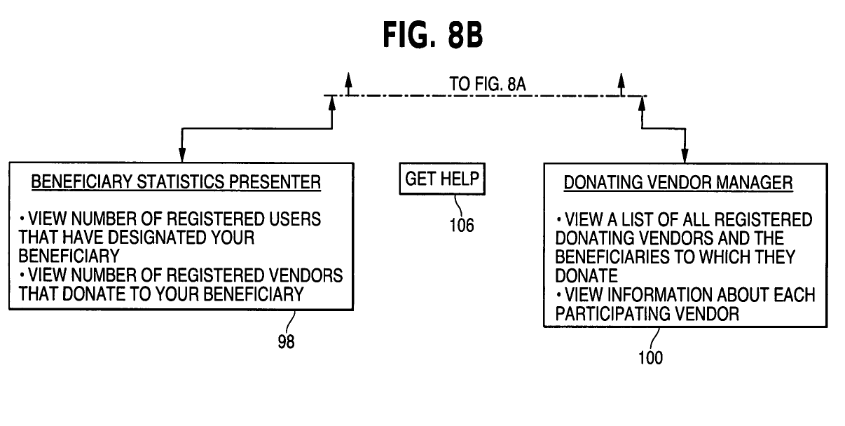

Referring now to FIG. 8, an exemplary embodiment of the beneficiary account manager 46 is shown. Upon a successful login, the web application server 24 provides the beneficiary account manager 46. The beneficiary account manager 46 has a number of options and further services for the beneficiary 16. These items, which will be discussed in more detail below, cause routines to be invoked to either implement the beneficiary's 16 request or request further information prior to implementing the beneficiary's 16 request. In one embodiment of the present invention, the beneficiary 16 may access several options through the beneficiary account manager 46, such as the beneficiary information manager 96, the beneficiary statistics presenter 98, the Internet vendor manager 100, the community manager 101, the donations received presenter 102, and policies and agreements presenter 104. A get help link 106 may also be available at the beneficiary account interface 46.

The beneficiary information manager 96 enables a beneficiary 16 to, among other things, view and change its contact and demographic information. For example, the beneficiary 16 can view and update its address, phone number, and email address. The beneficiary information manager 96 also enable the beneficiary 16 to view and change it bank account routing information. Further, the beneficiary information manager 96 allows the beneficiary to view and change its username and password. The beneficiary 16 can view and change its mission statement via the beneficiary information manager 96. For example, the mission statement provides Internet vendors 14 and Internet users 12 with information about services provided by the beneficiary 16. Further the mission statement indicates whether the beneficiary is a religious or secular organization.

The beneficiary 16 can access the statistics presenter 98 to, among other things, view the number of registered users 12 and vendors 14 that have designated the beneficiary 16. The beneficiary account manager 46 also includes an Internet vendor manager 100. The Internet vendor manager 100 provides a list of all registered vendors 14 and the corresponding beneficiaries 16 to which they donate. The Internet vendor manager 100 also provides information to the beneficiary 16 about each registered Internet vendor 14. Information provided by the Internet vendor manager 100 includes profile information, for example, whether the vendor 14 is a religious owned business, non-for-profit business, for-profit business, or a secular commercial business. Information obtained from the Internet vendor manager 100 enables beneficiaries 16 to efficiently and effectively solicit Internet vendor 14 and thereby encourage the Internet vendor 14 to donate to the beneficiary 16.

In an embodiment the community manager 101 enables the beneficiary 16 to select communities with which it wishes to associate. Communities, for example, consist of Internet vendors 14, Internet users 12, and beneficiaries 16 that belong to and/or support common religious, educational, ethnic, political communities, etc.

In an embodiment, the community manager 101 displays a list of all communities and the Internet users 12, Internet vendors 14, and beneficiaries 16 associated therewith. Upon the beneficiary's 16 request, the community manager 101 displays specific information about a particular community. For example, the beneficiary 16 can select a community, and the community manager 101 can display the community's mission statement, financial need, etc. The community manager 101 also contains a list of the most popular communities. The most popular communities, for example, are those communities comprising the largest number of Internet users 12, Internet vendors 14, and beneficiaries 16.

The beneficiary 16 can select communities by at least one of two ways. First, for example, the beneficiary 16 can manually select any number of registered communities. Second, for example, the beneficiary 16 can select ten registered communities and the community manager 101 will automatically associate with the most popular communities.

The beneficiary can access the donations received presenter 102 to view a statement of the total donations received and a statement of the total donations received per vendor 14. The beneficiary account manager 46 also includes a policy and agreement presenter 104. Upon initiation by the beneficiary 16, the policy and agreement present 104 displays current network 10 policies and agreements applicable to the beneficiary's 16 use of the network 10. These policies and agreements are defined by the administrator 18 and are agreed to by the beneficiary 16 during registration.

Referring again to FIG. 4, an exemplary embodiment of the web application server 24 comprising the administrator secure login 48 and the administrator account manager 50. For example, in operation the administrator 18 accesses the web application server 24, and the web application server 24 presents the administrator secure login 48. Upon access to the administrator secure login 48, the administrator 18 inputs a valid username and password.

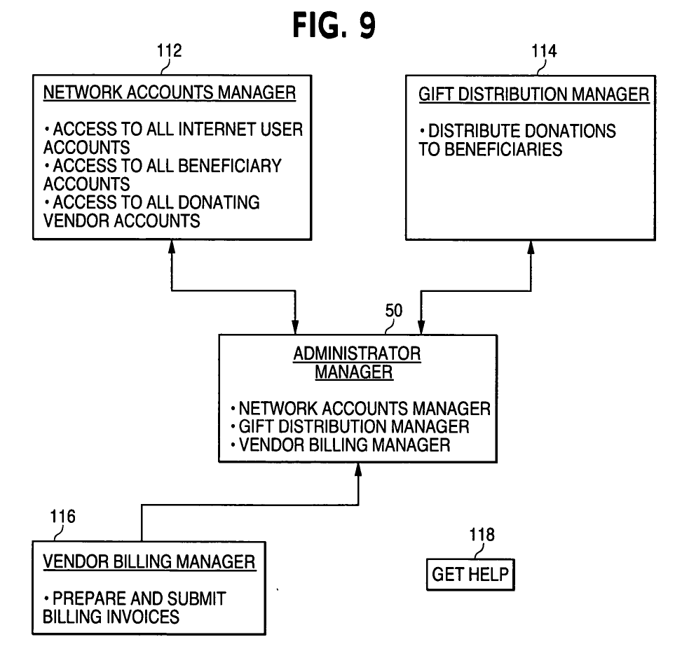

Referring now to FIG. 9, an exemplary embodiment of the administrator account manager 50 is shown. Upon a successful login, the web application server 24 provides the administrator account manager 50. The administrator account manager 50 has a number of options and further services for the administrator 18. These items, which will be discussed in more detail below, cause routines to be invoked to either implement the administrator's 18 request or request further information prior to implementing the administrator 18 request. In one embodiment of the present invention, the administrator 18 may access several options through the administrator account manager 50, such as the network accounts manager 112, gift distribution manager 114, and the vendor billing manager 116. A get help link 118 may also be available at the administrator account interface 50.

The network accounts manager 112 enables the administrator 18 to access and utilize the respective account managers of all registered Internet users 12, Internet vendors 14, and beneficiaries 16. The administrator 18 has access to all of the tools provided by the respective account managers. This access enables the administrator 18 to monitor network 10 activity from the prospective of all participants.

The network accounts manager 112 enables the administrator 18 to view and edit, among other things, posted mission statements, listed URLs, need statements, advertisements, etc. If a network 10 participant is not in compliance with network 10 policies, the administrator 18, by-way-of the network accounts manager 112, can deactivate the non-compliant account. Further, the network accounts manager 112 enables the administrator 18 to review and authorize each account upon registration of a new Internet user 12, Internet vendor 14, or beneficiary 16.

The gift distribution manager 114 distributes donations to beneficiaries 16. For example, the gift distribution manager 114 can either prepare a check or electronically route donations to beneficiaries 16. The billing manager 116 prepares billing invoices for submission to Internet vendors 14.

Referring now to FIGS. 10 and 11, embodiments of the smart client main page 140 are shown. Upon activation of the smart client 26, the smart client main page 140 is presented to the Internet user 12. The smart client main page 140 provides the option of browsing the network 10 via a search tool 142, a favorites tool 144, a purchases tool 146, and a discounts tool 148.

The search tool 142 facilitates the Internet user's 12 remote access to the web server 28 and executes a search request according to the procedure described previously. The web server 28 preferably generates and displays, via the smart client 26, a search result list in the ad display window 154. The previous search tool 143 stores resent searches conducted by the smart client 26. The Internet user 12 can access the previous search tool 143, select a previous search, and rerun the search.

The favorites tool 144 enables the Internet user 12 to save a search. This feature is distinct from the previous search tool 143 at least because the search can be saved and because the search can be assign a name. The discounts tool 148 enables Internet user 12 to designate products and services for which they are currently interested in buying. Internet vendors 14 can host, by category, discounts to Internet users 12. The discounts tool presents the discount information to the Internet users 12 by cross-referencing information in the Internet user account manager 42 and information in the Internet vendor account manager 38. The purchases tool 146 enables the Internet user 12 designate products and services that she/he plans to purchase. This information is provided to Internet vendors 14 and based on the information, the vendors 14 can directly advertise to the Internet user 12.

Also provided to the Internet user 12 is a my preferences button 150. The my preferences button 150 links the Internet user 12 to the Internet user account manager 42 where the user 12 can change his/her account settings. It should also be appreciated that the my preferences button 150 provides the internet user 12 with a menu of options applicable to the smart client 26. Further, a help button 152 is provided, which present a context specific help menu or connects the user to help webpage maintained by the administrator 18.

An Internet user 12 may invoke the smart client 26 to employ a pledge amount methodology to refine certain search results by indicating the pledge radio button 172. For example, as shown in FIG. 11, a search for “life insurance” may generate a list of life insurance providers 14 in descending order from the highest pledging company 14. The smart client 26 generates this list by referencing pledge amount information in the Internet vendor account manager 38.

Localization methodologies may also be employed to refine certain searches by indicating the local radio button 174. For example, a search for “life insurance” may be limited to those insurance providers 14 within a selected city, zip code, or telephone area code. It should also be appreciated that a search for “life insurance” may generate a list of life insurance providers 14 in descending order from the provider 14 closest to the Internet user 12. The smart client 26 generates this list by cross-referencing information in the Internet user account manager 42 and information in the Internet vendor account manager 38.

Also, a community methodology may be employed to refine searches by indicating the community radio button 174. For example, a search for “life insurance” may be limited to those vendors 14 within a selected religious, educational, ethnic, or political community. It should also be appreciated that a search for “life insurance” may generate a list of life insurance providers 14 in descending order from the provider 14 that shares a least a community with the Internet user 12. It should also be appreciated that a search for “life insurance” may generate a list of life insurance providers 14 in descending order from the provider 14 that donates to at least a community in which the Internet user 12 is a member. The smart client 26 generates this list by cross-referencing information in the Internet user account manager 42 and information in the Internet vendor account manager 38.

Moreover, an overall ranking methodology may be employed to refine searches by indicating the stars radio button 178. For example, the smart client 26 simultaneously applies the pledge amount methodology, the localization methodology, and the community methodology. Upon application of the pledge amount methodology, the localization methodology, and the community methodology, the smart client 26, in the preferred embodiment, ranks the vendors 14 in descending order from the vendor 14 having the highest average rank among all of the tests. Thus, a search for “life insurance” may generate a list of life insurance providers 14 in descending order from the provider 14 having the highest average rank among all of the tests. It should be appreciated that the smart client 26 can assign at least a star thumbnail 180 to each vendor's 14 hyperlink 182, and the number of star thumbnails 180 is directly proportional to the vendor's 14 average rank in the pledge amount methodology test, the localization methodology test, and the community methodology test. The smart client 26 generates this list and assigns the star thumbnails 180 by cross-referencing information in the Internet user account manager 42 and information in the Internet vendor account manager 38.

In an embodiment, the smart client 26 includes an auto-activation tool that either launches the smart client main page 140 or causes the browser toolbar button 186 to blink. If the user 12 clicks on the browser toolbar button 186, the smart client main page 140 will launch. For example, the auto-activation tool and activate the main page 140 when the smart client 26, based on the Internet user's 14 activity, finds a match when it cross-references information in the Internet user account manager 42 and information in the Internet vendor account manager 38. An example of the auto-activation tool is used by SideStep, Inc. in their toolbar application, which can be downloaded at www.sidestep.com.

In an embodiment, the smart client 26 can initiate a search in response to at least one of at least four stimuli. First, the smart client main page 140 can be activated by a contextual search activation. The smart client 26 automatically detects that a search activity is being employed at a search engine (e.g., GOOGLE, MSN, YAHOO, etc) or on a website having its own search engine and determines the search terms. Based on the detected search terms, the smart client 26 conducts its own search of the web server 28. Second, the smart client 26 cross-references the URLs on which the Internet user 12 lands with designated competitor URLs listed in the advertising parameters manager 60 of the vendor account manager 38. When an Internet user 12 lands on a designated URL, the smart client 26 presents the Internet vendor's 14 advertisement to the Internet user 12. Third, the smart client 26 scans the context of the web page being viewed by the Internet user 12 for keywords and search terms listed in the advertising parameters manager 60 of the vendor account manager 38. When an Internet user 12 lands on a web page containing designated keywords and search terms, the smart client 26 presents the Internet vendor's 14 advertisement to the Internet user 12. Fourth, the Internet user 12 manually inputs keywords and search terms into the search tool 142 and clicks on the go button 145.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for enabling an Internet user to appropriate a benefit by interacting with a website that is promoted by an Internet vendor, comprising:
an Internet vendor account for each of a plurality of Internet vendors registered in the system, wherein the Internet vendor account includes a pledge amount;
an Internet user account for each of a plurality of Internet users registered in the system; and
a smart client configured to present data of the Internet vendor account, monitor a user activity of the Internet user, and provide the user activity to a web server,
wherein the web server is configured to allocate the benefit based on the user activity.

2. The system of claim 1, further comprising a beneficiary account for each of a plurality of beneficiaries registered in the system.

3. The system of claim 1, wherein the benefit is appropriated to the Internet user.

4. The system of claim 1, wherein the benefit is appropriated to a beneficiary.

5. The system of claim 1, wherein the Internet user account includes a beneficiary to which the Internet user wishes to appropriate the benefit.

6. The system of claim 5, wherein the benefit is appropriated to the beneficiary upon interaction of the Internet user with the website promoted by the Internet vendor.

7. The system of claim 1, wherein the pledge amount is a landing page hit amount, and the landing page hit amount is the benefit appropriated when the Internet user clicks on a hyperlink of the Internet vendor.

8. The system of claim 1, wherein the pledge amount is a lead amount, and the lead amount is the benefit allocated when the Internet user submits a portion of the data of the Internet user account to the Internet vendor.

9. The system of claim 1, wherein the pledge amount is a qualified lead amount, and the qualified lead amount is the benefit appropriated when the Internet user submits a portion of the Internet user account to the Internet vendor and the Internet user provides the Internet vendor with an answer to each of a plurality of qualified lead questions.

10. The system of claim 1, wherein the pledge amount is a call amount, and the call amount is the benefit appropriated when the user activity results in the Internet user calling the Internet vendor.

11. The system of claim 1, wherein the web server is configured to cross-reference the user activity with data of the Internet vendor account to identify a common term, and the smart client is configured to present data of the Internet vendor account to the Internet user when the web server identifies the common term.

12. The system of claim 11, wherein the smart client is automatically activated when the web server identifies the common term.

13. The system of claim 12, wherein the smart client automatically activates by providing a highlighted browser toolbar button, and the Internet user can click on the highlighted browser toolbar button to launch the smart client.

14. The system of claim 12, wherein the smart client automatically activates by providing a message to the Internet user, wherein the message informs the Internet user of a similar Internet vendor offer.

15. The system of claim 1, wherein the smart client includes a popularity radio button configured to sort the plurality of Internet vendors by a popularity value, and the popularity value is based on a number of occasions the website of the Internet vendor is accessed by the plurality of Internet users.

16. The system of claim 15, wherein the smart client includes a pledge radio button configured to sort the plurality of Internet vendors by a pledge amount value, and the pledge amount value is based on the pledge amount of each of the respective Internet vendors.

17. The system of claim 16, wherein the smart client includes a local radio button configured to sort the plurality of Internet vendors by a proximity value, and the proximity value is based on a physical distance between a location of the Internet vendor and a user location of the Internet user.

18. The system of claim 17, wherein the smart client includes a star ranking system configured to sort the plurality of donating vendors by a star ranking value, and the star ranking value is based on the sum of the popularity value, the pledge value, and the proximity value.

19. The system of claim 1, wherein the smart client includes a drop-down list configured to display a plurality of recent search results.

20. The system of claim 1, wherein the smart client includes a my search tab configured to display a plurality of recent search results.

21. The system of claim 1, wherein the smart client includes a my favorites tab configured to display a plurality of saved search results.

22. The system of claim 1, wherein the smart client includes a my discounts tab configured to display a plurality of discounts offered to the Internet user by the Internet vendor.

23. The system of claim 1, wherein the smart client includes a my purchases tab configured to display a plurality of target Internet vendors that supply a potential purchase, and the potential purchase is designated by the Internet user.

24. The system of claim 1, wherein the smart client includes a my preferences button, wherein the my preferences button launches the Internet user login device.

25. A method for enabling an Internet user to appropriate a benefit by interacting with a website that is promoted by an Internet vendor, comprising:
maintaining a database having stored thereon:
an Internet vendor account for each of a plurality of Internet vendors registered in the system, wherein the Internet vendor account includes a pledge amount;
an Internet user account for each of a plurality of Internet users registered in the system;
monitoring a user activity of the Internet user;
cross-referencing the user activity with data of the Internet vendor account to identify a common term;
presenting data of the Internet vendor account when the common term is identified;
monitoring an interaction between the Internet user and the website that is promoted by the Internet vendor; and
allocating the benefit.

26. The method of claim 25, wherein the benefit is allocated to the Internet user.

27. The method of claim 25, wherein the benefit is allocated to a beneficiary.

28. The method of claim 25, wherein the database further comprising a beneficiary account for each of a plurality of beneficiaries registered in the system.

29. The method of claim 25, wherein the pledge amount is a landing page hit amount, and the landing page hit amount is the benefit allocated when the Internet user clicks on a hyperlink of the Internet vendor.

30. The method of claim 25, wherein the pledge amount is a lead amount, and the lead amount is the benefit allocated when the Internet user submits a portion of the Internet user account to the Internet vendor.

31. The method of claim 25, wherein the pledge amount is a qualified lead amount, and the qualified lead amount is the benefit allocated when the Internet user submits a portion of the Internet user account to the Internet vendor and the Internet user provides the Internet vendor with an answer to each of a plurality of qualified lead questions.

32. A method for providing an incentive to an Internet user to interact with a website, comprising:
monitoring a user activity of an Internet user;
searching a database for an Internet vendor based on the user activity;
presenting a hyperlink to a website that is maintained by the Internet vendor;
monitoring an interaction between the Internet user and the website; and
allocating a benefit.

33. The method of claim 32, wherein the benefit is allocated to the Internet user.

34. The method of claim 32, wherein the benefit is allocated to a beneficiary.

35. The method of claim 34, wherein the beneficiary is a charity.

36. The method of claim 32, wherein the beneficiary is selected by the Internet user.

37. The method of claim 32, further comprising the step of submitting a Internet user data to the Internet vendor upon the interaction.

38. The method of claim 32, further comprising the step of prompting the Internet user to submit a first marketing data to the Internet vendor.

39. The method of claim 38, further comprising the step of allocating a second benefit.

40. The method of claim 39, further comprising the step of prompting the Internet user to submit a second marketing data to the Internet vendor.

41. The method of claim 40, further comprising the step of allocating a third benefit.
